(19) United States
(12) Patent Application Publication
(10) Pub. No.: US 2015/0169255 A1
(43) Pub. Date: Jun. 18, 2015

(54) IMAGE PROCESSING APPARATUS, METHOD FOR CONTROLLING IMAGE PROCESSING APPARATUS, SYSTEM, AND STORAGE MEDIUM

(71) Applicant: CANON KABUSHIKI KAISHA, Tokyo (JP)

(72) Inventor: Junya Arakawa, Kawasaki-shi (JP)

(21) Appl. No.: 14/566,533

(22) Filed: Dec. 10, 2014

(30) Foreign Application Priority Data
Dec. 17, 2013 (JP) 2013-260388

(51) Int. Cl. G06F 3/12; G06K 15/00; G06K 15/02

(52) U.S. Cl. CPC G06F 3/121; G06K 15/027; G06K 15/408; G06F 3/1219; G06F 3/1204; G06F 3/1234

(57) ABSTRACT

An image processing apparatus includes an image forming unit configured to form an image, a designation unit configured to designate an area with respect to image data obtained by reading the image formed by the image forming unit, an acquisition unit configured to acquire image feature information of image data included in the area designated by the designation unit, an estimation unit configured to estimate a cause of an abnormal image included in the designated area by using the image feature information acquired by the acquisition unit, and a determination unit configured to determine a chart to be formed by the image forming unit by using an estimation result of the estimation unit.

### BACKGROUND OF THE INVENTION

1. Field of the Invention

The present invention relates to an image processing apparatus, a method for controlling the image processing apparatus, a system, and a storage medium for estimating an abnormality portion in a case where an abnormality occurs in a printer.

2. Description of the Related Art

An image inspection system has currently been available as one of service supports for image forming apparatuses. The image inspection system is used for analyzing an image with an abnormal image (hereinafter referred to as an abnormal image) from user in a service center at a remote location to swiftly solve a problem causing the abnormal image. The image inspection system is described below with reference to FIG. 2. In a conventional service support procedure 201, a user makes a service call to a service center when an abnormal image occurs. It is highly difficult for the service center, on the other end of the line, to identify an actually occurring phenomenon in a case of an abnormal image only through verbal communications. For example, when the user says “there is unevenness”, the cause of the unevenness cannot be identified without detailed information, such as a direction, a frequency, a cycle, or the like of the unevenness that has occurred. Thus, a service man makes a service visit to the user (a location where a printer is installed) to check the phenomenon. The service man outputs several sheets of images by the image forming apparatus of the user to check the abnormality to estimate a portion causing the abnormal image. Based on the estimation of the causing portion, the service man returns to the service center to acquire a replacement component, and then makes another service visit to the user. Thus, the service man makes at least two service visits to solve the problem. Such a procedure requires transportation cost of the service man, and further involves downtime during which the machine cannot be used until the service is completed, thereby largely degrading productivity of the user.

In a service support procedure 202 illustrated in FIG. 2 with the image inspection system, the user makes the service call to the service center in a case where an abnormal image occurs. The service center, on the other end of the line, requests the user to output an image inspection chart (analysis chart) and transmit image data obtained by scanning the output chart. The user outputs the image inspection chart and transmits the image data obtained by scanning the output chart to the service center in accordance with the instruction from the service center. In the service center, the image data transmitted from the user is analyzed by the image inspection system to analyze the cause of the abnormal image of the user. The service man makes the service visit to the user with a replacement component based on a result of the analysis. Thus, the cause of abnormal image can be eliminated by a single service visit. When no component needs to be replaced, and the cause of abnormal image can be eliminated by a simple setting, calibration, and the like, the problem can be swiftly solved by processing performed by the user to solve the problem.

As described above, when the image inspection system is utilized in the service center at the remote location, the time consumed by the user can be extremely shortened until the problem is solved after the problem has occurred, and the productivity can be prevented from degrading.

However, various types of image inspection charts need to be output to cover all the possible abnormal images.

Examples of the abnormal images include unevenness, stain, streak, toner scattering, and the like. To inspect all these abnormal images, various types of image inspection charts are required.

For example, even a chart having the same color and a uniform density over an entire sheet involves several tens of combinations considering a toner color, a type of halftone processing, and a density. More specifically, 36 combinations are obtained in a case where there are four types of toner colors including cyan, magenta, yellow, and black; three types of halftone processing including a high screen ruling, a low screen ruling, and error diffusion; and three types of densities including high density, medium density, and low density. Thus, 36 image inspection charts need to be output to cover all the combinations. In a case where secondary color of, for example, cyan and magenta is to be further output, the number of image inspection charts increases in accordance with the number of combinations between colors. The image inspection chart further includes various other charts, such as a thin line chart and a color patch chart. Thus, to cover all the possible abnormal images, an extremely large number of types of image inspection charts need to be output. A large number of output charts, as described above, results in a high inspection cost (paper and toner cost, for example) and more labor of the user for scanning the image inspection charts.

A method for reducing the number of output image inspection charts is discussed in Japanese Patent Application Laid-Open No 2008-224745. According to the method discussed in Japanese Patent Application Laid-Open No 2008-224745, a first test chart for an image inspection is output, and the first test chart thus output is scanned. In a case where the cause of an abnormal image cannot be identified from image data obtained by the scanning, an inspection chart to be output next is narrowed down based on a phenomenon occurring on the first test chart. Then, a second test chart to be output next is determined. The second test chart is output, and the output second chart is scanned to perform the image inspection to analyze the cause of the abnormal image.

According to the method described above, the inspection chart to be printed as the second test chart is determined from the result of scanning the first test chart. The method is based on the concept that the abnormal image occurs in the first test chart, but a cause of the abnormal image cannot be identified, and the second test chart is then printed to identify the cause of the abnormal image.

However, the abnormal image occurring in an output product output by the user, which is not the image inspection chart, may not always occur in the first test chart. The abnormal image may occur in a specific area in an image, a specific frequency, a specific color gamut, specific halftone processing, and the like. Thus, all the possible abnormal images are difficult to be covered with a small number of the first test charts. Thus, a large number of the first test charts are required to cover all the possible abnormal images, and thus outputting of the charts in two stages is no longer advantageous.

As described above, in the method described above, an aim to reduce the number of output charts may lead to a failure to identify a cause of an abnormal image. All things considered, a large number of charts need to be output to ensure identification of the cause of the abnormal image.

### SUMMARY OF THE INVENTION

According to an aspect of the present invention, image forming apparatus includes an image forming unit configured to form an image, a designation unit configured to designate an area with respect to image data obtained by reading the image formed by the image forming unit, an acquisition unit configured to acquire image feature information of image data included in the area designated by the designation unit, an estimation unit configured to estimate a cause of an abnormal image included in the designated area by using the image feature information acquired by the acquisition unit, and a determination unit configured to determine a chart to be formed by the image forming unit by using an estimation result of the estimation unit.

The present invention is directed to a technique for determining the number of image inspection charts to be output by using image feature information of an output product determined to have an abnormal image. Thus, inspection cost (paper and toner cost) and a labor of a user for scanning the charts can be reduced.

Further features of the present invention will become apparent from the following description of exemplary embodiments with reference to the attached drawings.

### BRIEF DESCRIPTION OF THE DRAWINGS

FIG. 1 is a configuration block diagram of an image inspection system.

FIG. 2 is a diagram illustrating conventional service support procedures.

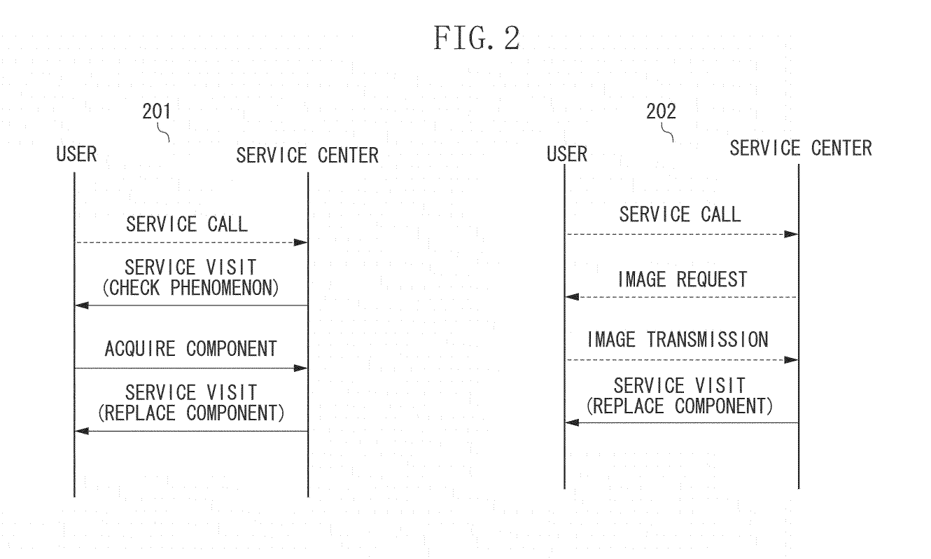

FIG. 3 is a diagram illustrating examples of abnormal images.

FIGS. 4A to 4E are diagrams each illustrating an example of an analysis chart.

FIG. 5 is a flowchart illustrating a processing procedure according to a first exemplary embodiment.

FIGS. 6A to 6C are diagrams each illustrating an example of an abnormal image according to the first exemplary embodiment.

FIGS. 7A to 7C are diagrams each illustrating an example of an image inspection chart determined by procedure according to the first exemplary embodiment.

FIGS. 8A to 8C are diagrams each illustrating an example of an abnormal image according to the first exemplary embodiment.

FIGS. 9A to 9D are diagrams each illustrating an example of an image inspection chart determined by procedure according to the first exemplary embodiment.

FIG. 10 is a flowchart illustrating a processing procedure according to a second exemplary embodiment.

FIGS. 11A and 11B are diagrams each illustrating an example of an integrated inspection chart according to the second exemplary embodiment.

### DESCRIPTION OF THE EMBODIMENTS

A first exemplary embodiment of the present invention is described below with reference to the drawings.

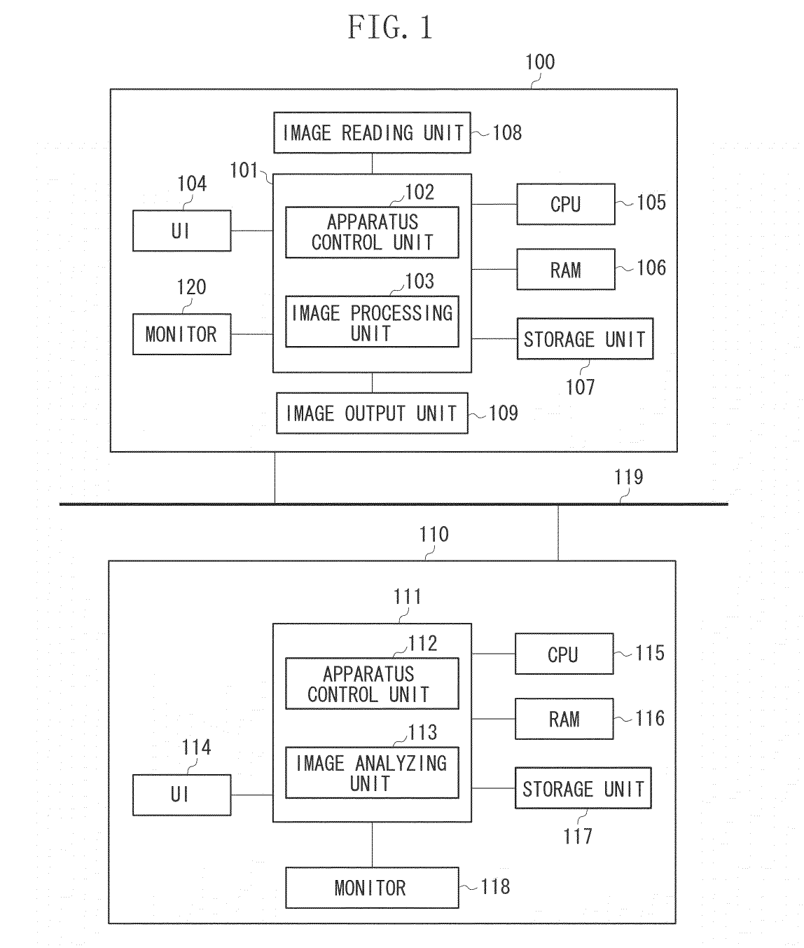

FIG. 1 is a block diagram illustrating a minimum possible configuration to implement the present exemplary embodiment. A control unit 101 of an image forming apparatus 100 includes an apparatus control unit 102 that controls the image forming apparatus 100 and an image processing unit 103 that optimizes image data. The control unit 101 uses a central processing unit (CPU) 105 and a random access memory (RAM) 106 to acquire an image from an image reading unit 108, process image data, and store the resultant data in a storage unit 107. The control unit 101 also performs output to an image recording medium with an image output unit 109 and output of an image for a user interface (UI) 104, such as a mouse and a keyboard, to a monitor 120. Various setting values, set with the UI 104, are stored in the storage unit 107 via the apparatus control unit 102. The image processing unit 103 included in the control unit 101 reads the setting values thus stored to process the image data. The storage unit 107 stores various setting values and the corresponding image for each processing as an image output history. The storage unit 107 further stores a parameter for controlling the image forming apparatus 100, an application for implementing the present exemplary embodiment, an operating system (OS), and the like. What is described above is the minimum possible configuration of the image forming apparatus 100 operated by a user, and thus a network interface, such as a router and a firewall, and a personal computer (PC) connected to the image forming apparatus 100, may be added as appropriate. A configuration required for the image forming apparatus 100 as a whole may be added.

An image inspection apparatus 110 is installed in a service center, and can be connected to the image forming apparatus 100 through a network 119. The image inspection apparatus 110 transmits and receives image data, management data, control data, and the like to and from the image forming apparatus 100 through the network 119.

A control unit 111 of the image inspection apparatus 110 includes an apparatus control unit 112 that controls the image inspection apparatus 110 and an image analyzing unit 113 that analyzes image data. The control unit 111 uses a CPU 115 and a RAM 116 to analyze image data transmitted from the image forming apparatus 100 and stored in a storage unit 117. Various instructions are issued to the control unit 111 via a UI 114, such as a mouse and a keyboard. The image analyzing unit 113 processes the image data based on the issued instruction. Alternatively, the instruction from the UI 114 is stored in the storage unit 117 or the RAM 116 via the apparatus control unit 112, and the image analyzing unit 113 reads out the instruction thus stored to analyze the image data. The apparatus control unit 112 outputs an image, a result of the analysis, instruction information from the UI 114, and the like to a monitor 118. What is described above is the minimum possible configuration of the image inspection apparatus 110 operated in the service center, and other interfaces may be added as appropriate. A configuration required regarding the image inspection apparatus 110 as a whole may be added. The image inspection apparatus 110 may be implemented by a server, a PC, or an information processing apparatus in the service center. However, this should not be construed in a limiting sense. The functions of the storage unit 117 and the image analyzing unit 113 may be partly implemented by a remote device connected to the image inspection apparatus 110 through the network 119, such as a cloud.

The image forming apparatus 100 may have the functions of the image inspection apparatus 110. More specifically, the image forming apparatus 100 may include the configuration required for the image inspection apparatus 110 to perform an image inspection.

Specific example of an abnormal image, an analysis chart, and an analysis method are described below.

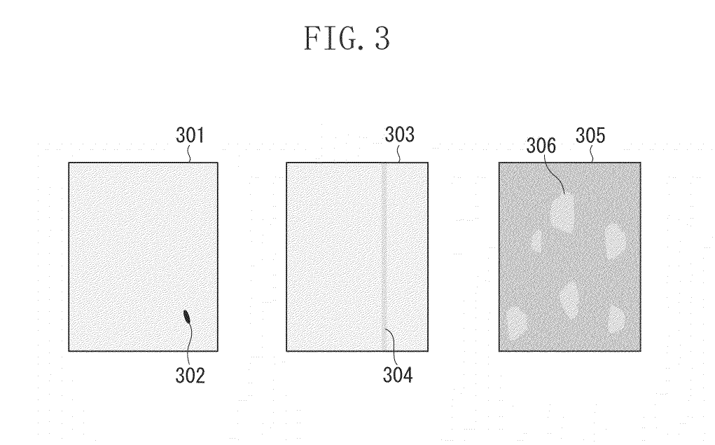

FIG. 3 is a diagram illustrating specific examples of abnormal images that occur in the image forming apparatus 100. For example, the abnormal images include a dust problem 301 in which a small stain 302 is attached to the output image, a streak problem 303 in which a line 304 in a longitudinal or lateral direction is formed in the image, and an unevenness problem 305 in which abnormalities 306 in the forms of a dot and a line are visually recognizable in the entire image. Furthermore, the abnormal images include problems (not illustrated), such as a color problem related to a color, a scattering problem due to toner scattering by the heat of a fixing unit that occurs mainly in the form of a thin line, a stain problem in which unwanted toner attaches to the output image, and a problem known as ghost in which a printed content in an upper portion of a sheet affects a lower portion of the sheet. Still furthermore, the abnormal images include a geometric distortion problem in which a straight line is distorted and a color shift problem in which toner printed positions are shifted from each other. Abnormal images other than the typical abnormal image examples described above that user feels inappropriate occur due to various causes in the image forming apparatus 100. The case where the user feeling inappropriate indicates a case where image data instructed to be output is output in a state of being different from the originally intended data, or a case where an output image includes an image not in the image data instructed to be output by the user or a stain.

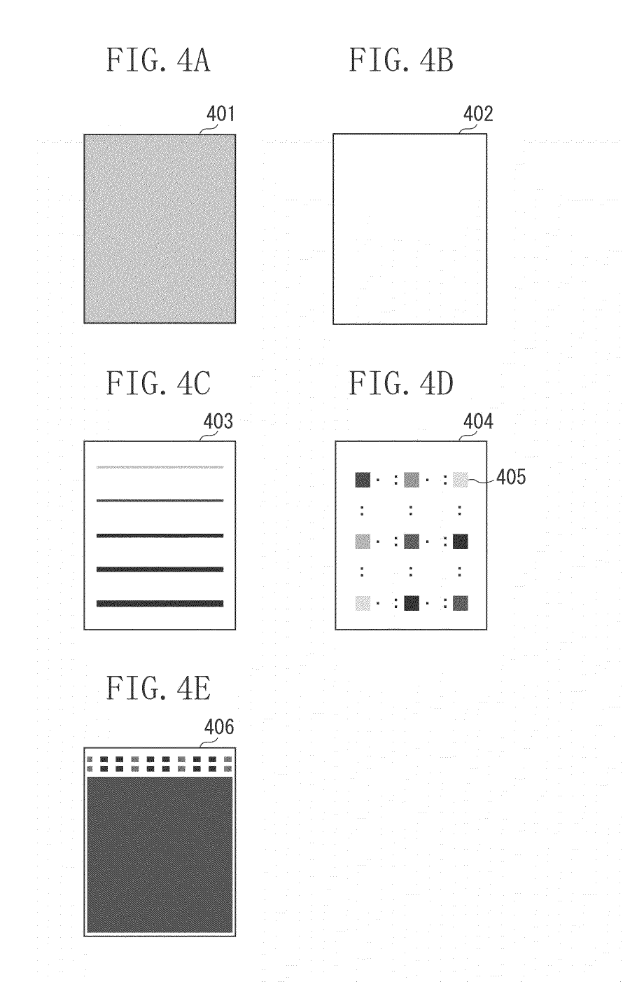

An image analysis method executed by the image analyzing unit 113 of the image inspection apparatus 110 is described along with examples of image inspection charts required for the analysis. FIG. 4 illustrates specific examples of the image inspection charts. FIG. 4A is an example illustrating a solid chart 401 having the same color over the entire area. The solid chart 401 is suitable for analyzing the dust problem 301, the streak problem 303, and the unevenness problem 305.

The image forming apparatus 100 includes a drum and a developing device that are not illustrated. The image forming apparatus 100 transfers and fixes toner attached on the drum to a paper sheet and fixes the toner to produce an output product. Generally, the image forming apparatus 100 having a color printing function includes the drums respectively corresponding to cyan, magenta, yellow, and black colors. Thus, the solid chart 401, as the image inspection chart, is required for each color with an abnormal image. For example, in a case where it is determined that the abnormal image is occurring in cyan and magenta images, the solid chart 401 for cyan and the solid chart 401 for magenta are required.

The density of the solid chart 401, which is not limited to the illustrated density, is required to be in a density region facilitating the detection of the abnormal image.

The density region facilitating the detection is described in detail below.

For example, a case where the unevenness problem 305 is the image problem to be detected is described. The unevenness problem 305 may be caused by a white void due to inappropriate toner fixing. In such a case, the density of the solid chart 401 is preferably high, so that the unevenness problem 305 can be more easily recognized with a high contrast between the white void portion and a portion where the toner is appropriately fixed. On the other hand, the unevenness problem 305 may be caused by a reproducibility of isolated dots. In such a case, the density of the solid chart 401 is preferably low, so that the unevenness problem 305 can be more easily recognized with a large number of isolated dots produced by halftone processing.

As described above, the density of the solid chart 401 needs to be changed in accordance with the density of the abnormal image to be detected. Thus, the solid chart 401 may be a single solid chart covering densities corresponding to all the abnormal images to be detected. In a case where all the densities cannot be covered by a single solid chart, a plurality of solid charts may be prepared.

The abnormal image might only be produced with a certain type of halftone processing. Thus, the solid charts 401 generated by a plurality of types of half tone processing are also required.

FIG. 4B is an example illustrating a blank chart 402 for analyzing the abnormal image, which is unrelated to printing processes, such as the staining problem described above. A failure to output a blank sheet including no print information (no stain) in a case where the blank sheet chart 402 is output indicates an occurrence of a problem unrelated to the printing processes. Thus, the abnormal image can be analyzed based on the nature of the output image.

FIG. 4C is example illustrating a thin line chart 403, in which thin lines are drawn, for detecting the scattering problem, the geometric distortion problem, and the color shift problem described above or the like. The thin line chart 403 is not limited to the illustrated one and any chart other than the thin lines may be used as long as a problem specific to a fine drawing and small characters.

FIG. 4D is an example illustrating a color patch chart 404 used for analyzing the color problem described above. The color patch chart 404 is formed by arranging patches 405 of single colors and mixed colors as appropriate. The patches 405 of the same color needs to be arranged in longitudinal or lateral direction to analyze the color uniformity in the longitudinal or the lateral direction. The color of the patch 405 needs to be changed in accordance with the color gamut of the color problem to be analyzed. Thus, a plurality of charts, which are different from each other in the color gamut of the patch 405, is required to cover various color problems.

FIG. 4E is an example illustrating a ghost chart 406 for detecting the problem known as the ghost described above. The ghost is a problem in which a printed content in an upper portion of a sheet affects the image density of a lower portion of the sheet. The ghost chart 406 includes patches with different densities in an upper portion and a solid portion in a lower portion. When the ghost occurs, a level difference of density in a patch form occurs in the solid portion of the output ghost chart 406. The ghost occurs with each color and the effect of the ghost differs according to the types of halftone processing. Thus, the ghost chart 406 is required for each color and each type of halftone processing to cover all types of ghosts.

In the analysis using the solid chart 401 and the blank chart 402, whether an image, being uniform as a whole, includes a portion different from the periphery in feature information needs to be determined. For example, an analyzing method using a change of a signal value, or a method for analyzing whether a component other than DC components is detected by frequency analysis may be employed. In the analysis using the thin line chart 403, whether there is scattering, bleeding, distortion, or a color shift around a thin line needs to be determined. For example, an area around a thin line to be analyzed is inspected in detail to distinguish between a normal state and a state where the abnormal image has occurred.

Alternatively, a thin line area is detected by edge detection, character determination processing for detecting a character area, or the like. The character determination processing has conventionally been employed to output black characters with high quality in copying. Then, the thin line area is analyzed in terms of the level of edge rounding, difference in color from a paper white portion around the edge due to the scattering of toner to the paper white portion, edge distortion, edge coloring, and the like. In the analysis using the color patch chart 404, data on each of the patch 405 is first acquired. Generally, an average of pixel values in a subarea in the patch 405 is extracted as a patch value. A method may be employed in which the difference between the normal state and the state where the abnormal image has occurred is analyzed by using the value thus extracted, in a case where the patches 405 of the same color is arranged in an image, the uniformity in the image is analyzed by comparing the patches 405. In an analysis using the ghost chart 406, the solid portion in the lower portion of the ghost chart 406 is analyzed with the same method as that used in the solid chart 401 and the blank chart 402, to analyze whether there is a level difference of density in the patch form. The analysis methods described above are merely examples, and any method may be employed as long as an abnormal image to be inspected can be appropriately analyzed.

As described above, the image analyzing unit 113 of the image inspection apparatus 110 applies a chart suitable for the image inspection to identify the cause of the abnormal image. The image forming apparatus 100 outputs the chart actually to be used. A method for outputting a chart in the image forming apparatus 100 is described below.

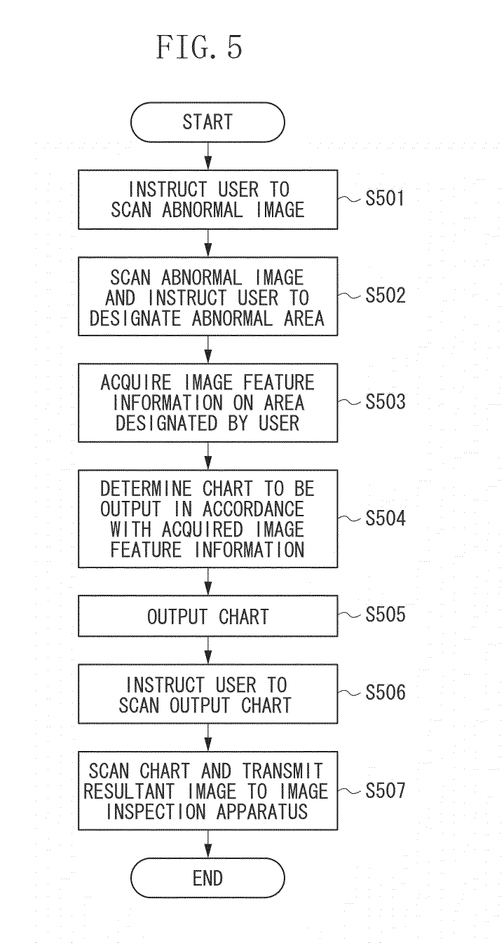

FIG. 5 illustrates a processing procedure in the image forming apparatus 100 according to the present exemplary embodiment, which will be described in detail below. A control program (not illustrated) for implementing the present exemplary embodiment is stored in the storage unit 107. The control program is loaded onto the RAM 106 to be executed by the CPU 105. A description is given below under the assumption that an image analysis mode installed in the image forming apparatus 100 in advance is executed by the user, and the operation proceeds along a procedure.

In step S501, the CPU 105 instructs the control unit 101 of the image forming apparatus 100 to generate an image and display the image on the monitor 120 for instructing the user to scan an image in which an abnormality image has occurred. The abnormal image has occurred in an output image output by the user, and thus the instruction to scan the actual output image in which the abnormal image has occurred is given to the user.

In step S502, the CPU 105 that has received a user's instruction from the UI 104 controls the image reading unit 108 through the control unit 101 to scan the output image in which the abnormal image has occurred. The control unit 101 stores the scanned image in the storage unit 107 and then displays the scanned image on the monitor 120 to instruct the user to designate an area where the abnormal image has occurred using the UI 104. The user designates the area where the abnormal image has occurred by using the UI 104. The user may draw any closed curved line on the monitor 120 using a touch panel or a mouse to designate the area. Alternatively, the user may designate the area by changing the position and the size of a frame displayed on the monitor 120 in advance, or designate coordinates on the image displayed on the UI 104.

The user may be capable of designating a plurality of areas. In such a case, processing in the next step and after may be executed for each area. A method for designating the area is not limited to the ones described above.

In step S503, the control unit 101 extracts the area designated by the user in step S502 from the scanned image stored in the storage unit 107, and acquires image feature information of the area. The image feature information is information that can be used to estimate the possible cause of the abnormal image. The CPU 105 may analyze the image feature information by using the image processing unit 103 or may directly analyze the image on the RAM 106.

The image feature information is analyzed with a method different from the image analysis method for identifying the cause of the abnormal image performed in the image analyzing unit 113 in the image inspection apparatus 110. The analysis at this point is performed to analyze the image feature information that can be used to narrow down charts. Thus, the analysis required herein is not a detail analysis with a large computational load, such as that performed in the image inspection apparatus 110, but is something that can be performed in the image forming apparatus 100. That is, the image feature information is not used to perform the final identification of the cause of the abnormal image, and is used to estimate a possible cause of the abnormal image.

The image feature information includes a type of halftone processing used for forming an image in the designated abnormal image area, a color used for forming the image in the designated abnormal image area, a percentage of a background area in the image in the designated abnormal image area. The image feature information may further include a percentage of characters/lines included in the image in the designated abnormal image area and a relative position of the image included in the designated abnormal image area in the entire image. The image feature information may be acquired by comparing the digital data of the output image with the scanned image.

In a case where the type of the halftone processing is used as the image feature information, the image feature information is information indicating whether the type of halftone processing, which is used for forming the image in the designated abnormal image area, is the screen or the error diffusion. In a case where the type of the halftone processing is the screen, information indicating the type of the screen is the image feature information.

The type of the screen can be determined based on the peak frequency in a frequency space and a relationship between the screen that can be processed by the image processing unit and the frequency, regarding the abnormal image area designated by the user.

In a case where the color is used as the image feature information, the image feature information is information indicating a toner color used for the image forming. The toner color may be a single color of cyan, magenta, yellow, or black, a secondary color, or a mixture of three colors or more. The image feature information further includes density/color gamut information indicating the density region and the color gamut forming the abnormal image area.

In a case where the percentage of the background area is used as the image feature information, the image feature information is information indicating the percentage of the background area (an area with a predetermined density or lower) of the image included in the abnormal image area. Thus, the information indicates whether the abnormal image area includes a paper background area.

In a case where the percentage of the characters/lines is used as the image feature information, the image feature information is information indicating the percentage of an area, which is estimated as a character/line area with continued strong edges, in the abnormal image area.

In a case where the relative position in the entire image is used as the image feature information, the image feature information is information indicating the position of the abnormal image area and the position of an adjacent object image of the abnormal image. Thus, the information indicating the position of the abnormal image area indicates whether the abnormal image area is in an end portion, a lower portion, or the like of the entire scanned image. The information indicating the position of the adjacent object image is information indicating whether there is an area with a similar image feature (such as color) around the abnormal image area. These types of image feature information may be acquired by a known image feature extraction technique, such as frequency analysis and region determination.

In step S504, the CPU 105 estimates the cause of the abnormal image in accordance with the image feature information acquired in step S503 to determine an analysis chart to be output to narrow down the number of the analysis charts.

A method for determining the analysis chart by using the color as the image feature information is described. In a case where the designated abnormal image area is formed of a single color, the problem is likely to occur in an image formed by a toner of the color, and thus the solid chart 401 of the single color is determined as the analysis chart. In a case where the abnormal image area includes a single mixed color, the solid charts 401 of each color forming the mixed color are determined as the analysis charts. In a case where the abnormal image area includes a plurality of mixed colors, the color reproducibility might be the issue. Thus, the color patch chart 404 is determined as the analysis chart, in addition to the solid chart 401. The density of the solid chart 401 and the color gamut of the color patches of the color patch chart 404 are determined by using the density/color gamut information.

A Method for determining the analysis chart by using the other types of image feature information will be described.

A case where the percentage of the background area is used as the image feature information is described. In a case where a high percentage of the background area is acquired in the designated abnormal image area, the abnormal image area is likely to include the paper background area. Thus, the abnormal image, which is unrelated to an object in the output image, such as the attaching of a stain, is likely to have occurred. Therefore, the blank chart 402 is determined as the analysis chart.

A case where the percentage of the characters/lines is used as the image feature information will be described. In a case where a high percentage of the characters/lines is acquired in the designated abnormal image area, the abnormal image specific to characters/lines is likely to have occurred. Thus, the thin line chart 403 is determined as the analysis chart.

A case where the relative position in the entire image is used as the image feature information is described.

In a case where the designated abnormal image area is in an image end portion of the entire image obtained by the scanning, the abnormal image specific to the image end portion is likely to have occurred. Thus, a chart suitable for such an abnormal image is determined as the analysis chart.

For example, only the image end portion might include unevenness caused by white voids due to inappropriate toner fixing. In such a case, the solid chart 401 with a high density is suitable for the analysis, and thus is determined as the analysis chart.

In a case where there is an area with a similar image feature around the abnormal image area, the ghost might have occurred. Thus, the ghost chart 406 is determined as the analysis chart. The color of the ghost chart 406 is determined by using the color-related image feature information.

The analysis chart is output by using a method that is the same as that in the type of halftone processing indicated by the image feature information acquired in step S503. Because some abnormal images look different depending on the method of the halftone processing, the method that is the same as that of the halftone processing used for outputting the designated image area is used for outputting the analysis chart. Thus, the abnormal image that has occurred in the output image of the user is likely to be reproduced in the output analysis chart.

In step S505, the CPU 105 generates the analysis chart determined in step S504, and causes the control unit 101 to output the analysis chart from the image output unit 109. In a case where the user designates a plurality of abnormal image areas, the analysis charts determined for each of the plurality of abnormal image areas are output in step S505. In such a case, the same charts are not redundantly output.

In step S506, the CPU 105 causes the control unit 101 to generate an image and display the image on the monitor 120 to instruct the user to scan the output chart.

In step S507, the CPU 105 that has received the instruction issued by the user from the UI 104 causes the image reading unit 108, through the control unit 101, to scan all the output analysis charts. The control unit 101 temporarily stores the scanned images in the storage unit 107, and transmits the stored images to the image inspection apparatus 110 through the network 119.

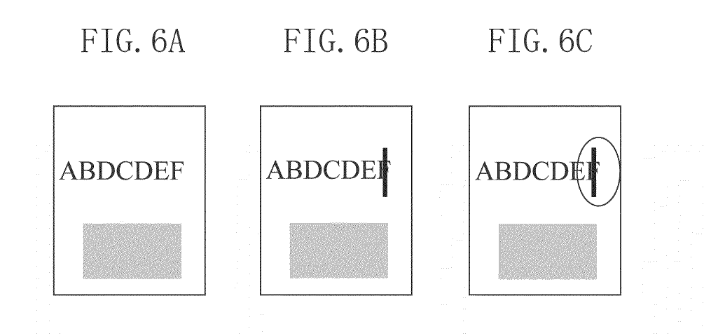

The processing procedure of the present exemplary embodiment is as described above. An example of processing in steps S501 to S5504 in the procedure is described with reference to FIGS. 6A to 6 C and 7A to 7B. FIG. 6A is an image illustrating digital data output by the user. FIG. 6B an image illustrating an actual output image as a result of outputting the image illustrated in FIG. 6A on a paper sheet. The image illustrated in FIG. 6B has a black line extending in the longitudinal direction on a right side that is recognized by the user as the abnormal image. The user initiates the image inspection to solve the cause of the abnormal image.

In step S501, the user places the image illustrated in FIG. 6B, which is output on the paper sheet, on the image reading unit 108 in accordance with the instruction from the image forming apparatus 100. In step S502, the image forming apparatus 100 scans the image illustrated in FIG. 6B. Thus, a preview image as a result of scanning the image illustrated in FIG. 6B is displayed on the monitor 120. The abnormal image area is designated with respect to the preview image displayed on the monitor 120. For example, the user designates the abnormal image area with respect to the scanned image displayed on the monitor 120 by using the UI 104. FIG. 6C is an image illustrating the image after the designation of the abnormal image area. An area surrounded by an oval in FIG. 6C is the designated abnormal image area. In step S503, the image forming apparatus 100 analyzes an image in the abnormal image area illustrated in FIG. 6C to acquire the image feature information. The acquired image feature information includes information on a color indicating that the toner color is a single color of black and the toner density is high. The percentage of the background area included in the acquired image feature information is high because the image includes a large background area estimated to be the paper white portion. The percentage may be provided as a specific numerical value.

The percentage of the characters/lines included in the acquired image feature information is high because the image includes a continuous strong edge.

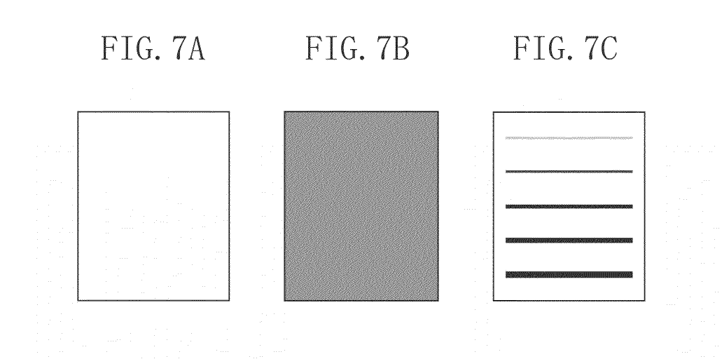

The type of halftone processing included in the acquired image feature information is the error diffusion. The acquired image feature information does not include any other notable feature. In step S504, the image forming apparatus 100 determines the analysis chart to be output based on the image feature information acquired in step S503. The image in the abnormal image area illustrated in FIG. 6C has a high percentage of the background area, and thus a blank chart illustrated in FIG. 7A is determined as the analysis chart. The toner color is a single color of black and with a high density, and thus a solid chart of a single color of black with a high density illustrated in FIG. 7B is determined as the analysis chart. The percentage of the characters/lines is high, and thus a thin line chart illustrated in FIG. 7C is determined as the analysis chart. The type of halftone processing of all the analysis charts is the error diffusion.

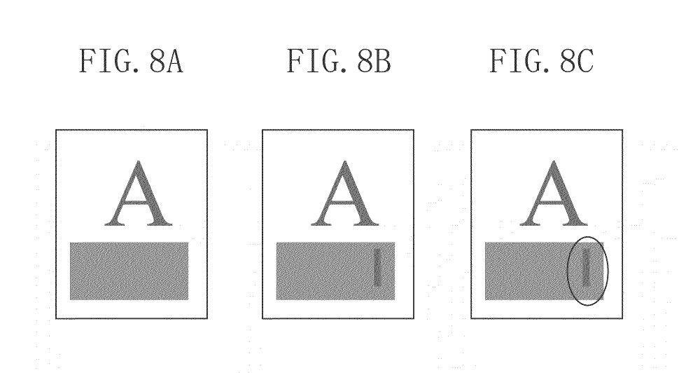

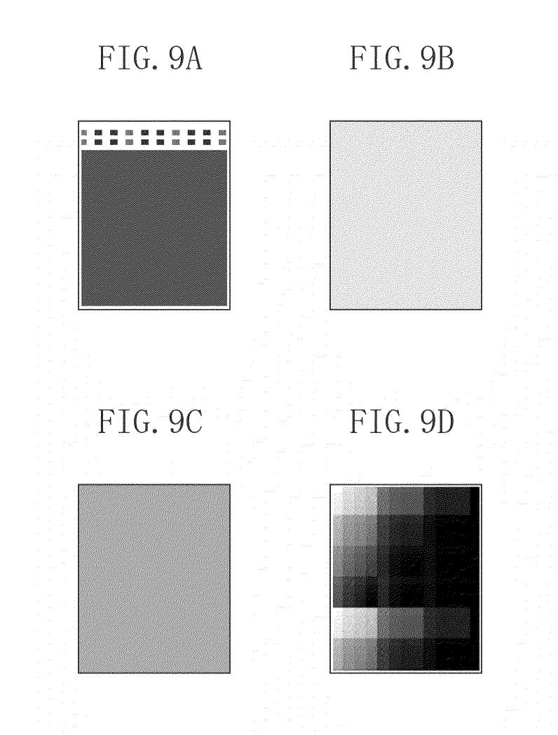

Another example of the processing is described with reference to FIGS. 8A to 8C and 9A to 9D.

FIG. 8A is an image illustrating digital data of an image intended to be output by the user. In the image illustrated in FIG. 8A, a character portion in an upper portion and a solid portion in a lower portion are both reproduced in a blue based color. FIG. 8B is an image illustrating an actual output image as a result of outputting the image illustrated in FIG. 8A on a paper sheet. In the image illustrated in FIG. 8B, the lower blue based color area includes another blue based color area with a different density that is recognized as the abnormal image by the user. The user initiates the image inspection to solve the cause of the abnormal image.

In step S501, the user places the image illustrated in FIG. 8B, which is output on the paper sheet, on the image reading unit 108 in accordance with the instruction from the image forming apparatus 100. In step S502, the image forming apparatus 100 scans the image illustrated in FIG. 8B. An image as a result of scanning the image illustrated in FIG. 8B is displayed on the monitor 120. The abnormal image area is designated with respect to the displayed image. For example, the user designates the abnormal image area with respect to the scanned image displayed on the monitor 120 by using the UI 104. An area surrounded by an oval in FIG. 8C is the abnormal image area designated by the user. In step S503, the image forming apparatus 100 analyzes an image in the abnormal image area illustrated in FIG. 8C to acquire the image feature information. The acquired image feature information includes information on color indicating that the toner color is a mixed color of cyan and magenta, that the toner densities of the cyan and magenta are both medium density, and that there is an area with a different density and color impression.

The position-related image feature included in the acquired image feature information indicates that there is an area in the upper portion of the image having a color similar to the color in the abnormal image area.

The type of halftone processing included in the acquired image feature information indicates a specific screen ruling. The acquired image feature information does not include any other notable feature.

In step S504, the image forming apparatus 100 determines the analysis chart to be output based on the image feature information acquired in step S503. In the abnormal image area illustrated in FIG. 8C, since there is an area in the upper portion of the image having a color similar to the color in the abnormal image area, the ghost might have occurred. Therefore, a ghost chart illustrated in FIG. 9A is determined as the analysis chart. An output color of the ghost chart is determined to be the color having a similar color impression as the color in the abnormal image area.

Because the toner color is the mixed color of cyan and magenta, a solid chart with a single color of cyan with a medium density illustrated in FIG. 9B and a solid chart with a single color of magenta with a medium density illustrated in FIG. 9C are determined as the analysis charts. Because there is an area with a different density and color impression, a color patch chart illustrated in FIG. 9D with color patches of blue based color, which are output in various densities, is determined as the analysis chart.

The type of halftone processing of all the analysis charts is the screen ruling set to be the same as that indicated by the image feature information acquired in step S503.

As described above, by using the image feature information of the abnormal image area in the actual user output product with the abnormal image, the number of the analysis charts to be output can be narrowed down and thus can be reduced. Consequently, the inspection cost (paper and toner cost) and the labor of the user for scanning the charts can be reduced.

Because the image feature information acquired from the area where the abnormal image has actually occurred is used, the image inspection is less likely to be dysfunctional due to the failure to reproduce the abnormal image on output analysis charts.

In a second exemplary embodiment, only a portion different from the first exemplary embodiment is described. According to the second exemplary embodiment, processing of integrating a plurality of types of analysis charts that would otherwise be output in a plurality of sheets into a single sheet by using the geometric feature of the abnormal image area is performed in addition to the processing according to the first exemplary embodiment. Accordingly, the number of analysis charts to be output can be further reduced. The number of analysis charts is further reduced by narrowing down based on an output condition of an output image with an abnormal image and additional information, which is other than the image feature information of an abnormal image area, such as information from the user. Accordingly, the number of analysis charts to be output can be further reduced.

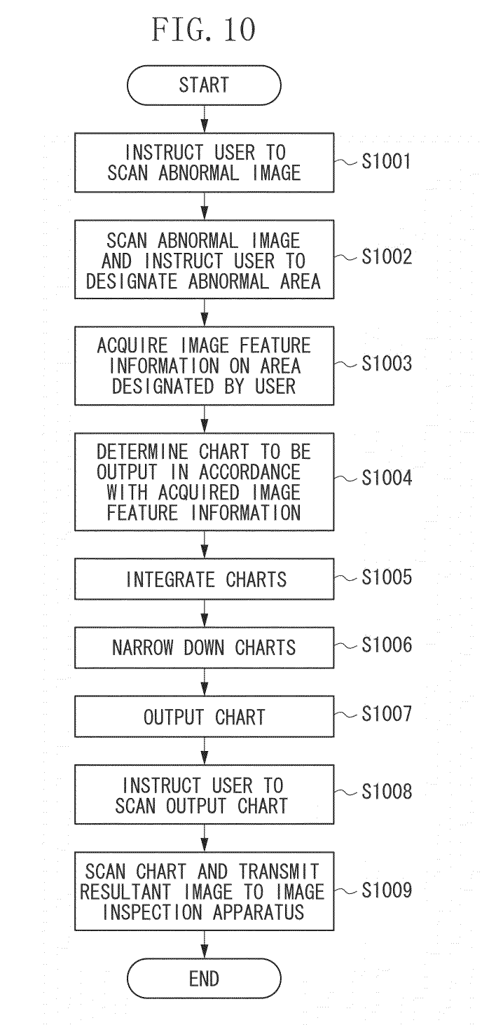

FIG. 10 illustrates a processing procedure in the image forming apparatus 100 in the present exemplary embodiment, which will be described in detail below. A control program (not illustrated) for implementing the present exemplary embodiment is stored in the storage unit 107 and is loaded onto the RAM 106 to be executed by the CPU 105. A description is given below under the assumption that an image analysis mode installed in the image forming apparatus 100 in advance is executed by the user, and the processing proceeds along the procedure.

Steps S1001 and S1002 are respectively similar to steps S501 and S502 in the first exemplary embodiment.

In step S1003, the control unit 101 extracts the area designated by the user from the scanned image stored in the storage unit 107, and acquires image feature information of the area, as similar in step S503. In step S1003, the control unit 101 further acquires a geometric shape of the abnormal image area in addition to the image feature information. The geometric form is information related to the geometric form, such as the lengths of the abnormal image area in the longitudinal and lateral directions, an aspect ratio, and a percentage of the abnormal image area in the entire scanned image.

Step S1004 is similar to step S504 in the first exemplary embodiment.

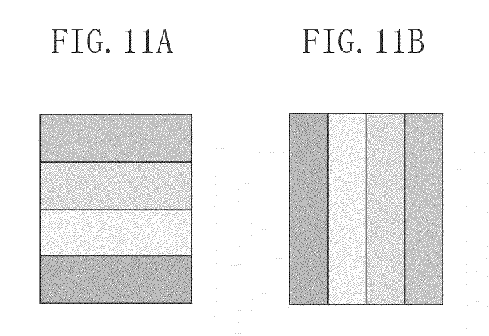

In step S1005, the CPU 105 uses the geometric shape acquired in step S1003 to integrate the analysis charts determined in step S1004. The abnormal image area having a certain geometric shape can be analyzed without problem even in a case where a plurality of analysis charts is integrated. Thus, a plurality of types of charts is integrated. In a case where the abnormal image area extends in the longitudinal direction and thus is expected to be a longitudinal streak, a plurality of types of solid charts is integrated. For example, a chart in the form of strips in the lateral direction as illustrated in FIG. 11A is determined as the analysis chart. This chart can be employed because if the abnormal image area extends in the longitudinal direction, the abnormal image is supposed to occur in individual portions in the integrated analysis chart. Similarly, in a case where the abnormal image area extends in the lateral direction, and thus is expected to be a lateral streak, a plurality of types of solid charts is integrated. For example, a chart in the form of strips in the longitudinal direction as illustrated in FIG. 11B is determined as the analysis chart.

In step S1006, the CPU 105 narrows down the analysis charts determined in step S1005 by using the additional information other than the image feature information. The number of the types of the charts to be output might be large if the charts are narrowed down by using the image feature information only. For example, the types of halftone processing indicated by the image feature information might not be able to be narrowed down to one, whereby the abnormal image might be determined to be formed by N types of halftone processing. In such a case, N types of analysis charts, different from each other in the halftone processing, needs to be output for each sheet of analysis chart which is before the halftone processing.

In a case where a complex area including a monotone area, a character area, and a photograph area is designated as the abnormal image area, a plurality of combinations of the image feature information might be acquired. Thus, the number of analysis charts to be output might be large. Therefore, the analysis charts are narrowed down by using the additional information to reduce the number of analysis charts.

The types of the halftone processing is narrowed down to the ones that were likely to have been used, based on the various setting values of the image output history stored in the storage unit 107. In a case where the storage unit 107 also stores the output image, an image corresponding to the abnormal image may be designated among the images stored in the storage unit 107 by using the image feature information on the entire abnormal image scanned in accordance with the instruction from the user. The analysis charts are narrowed down by using various setting values associated with the identified image.

The additional information may be collected from the user. More specifically, information, such as the toner color with the problem, the type of the problem (stain, color shift, streak, and the like), and the like that can be easily answered by the user through the UI 104 and the monitor 120 is collected. The colors of the analysis chart to be output are narrowed down by using the additional information thus input from the user, for example, to narrow down the analysis charts. In a case where the additional information is collected from the user, an operational load on the user is increased. Thus, the processing described above may be executed in a case where the number of analysis charts to be output exceeds a predetermined threshold. Steps S1007 to S1009 are respectively similar to steps S505 to S507 in the first exemplary embodiment. The analysis chart output in step S1007 is the analysis chart finally determined in step S1006.

The processing procedure according to the present exemplary embodiment is as described above. A plurality of types of analysis charts are integrated by taking the geometric shape of the abnormal image area into consideration, and the analysis charts are further narrowed down by using the additional information other than the image feature information. Thus, the number of analysis charts to be output can be further reduced.

Consequently, the cost required for the inspection (paper and toner cost), and the labor of the user for scanning the charts can be reduced.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like. While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-260388 filed Dec. 17, 2013, which is hereby incorporated by reference herein in its entirety.

What is claimed is:

1. An image processing apparatus comprising:
an image forming unit configured to form an image;
a designation unit configured to designate an area with respect to image data obtained by reading the image formed by the image forming unit;
an acquisition unit configured to acquire image feature information of image data included in the area designated by the designation unit;
an estimation unit configured to estimate a cause of an abnormal image included in the designated area by using the image feature information acquired by the acquisition unit; and
a determination unit configured to determine a chart to be formed by the image forming unit by using an estimation result of the estimation unit.

2. The image processing apparatus according to claim 1, further comprising a transmission unit configured to transmit image data obtained by forming the determined chart by the image forming unit and by reading the formed chart, to an apparatus connected to the image processing apparatus.

3. The image processing apparatus according to claim 1, wherein the image feature information is at least one of pieces of information on a color of an image included in the designated area, a halftone processing method used for forming the image included in the designated area, a percentage of a background area in the image in the designated area, a percentage of characters/lines in the image in the designated area, and a position of the image of the designated area.

4. The image processing apparatus according to claim 1, wherein the designation unit displays a preview image of the image data obtained by reading the image formed by the image forming unit, and the area is designated with respect to the displayed preview image.

5. The image processing apparatus according to claim 1 further comprising an integration unit configured to integrate a plurality of types of charts determined by the determination unit into a single sheet.

6. The image processing apparatus according to claim 5, wherein the integration unit is configured to integrate the charts in a case where a number of charts determined by the determination unit is larger than a threshold value.

7. The image processing apparatus according to claim 5, wherein the integration unit is configured to integrate a plurality of analysis charts into a single sheet by using information obtained from a shape of the designated area.

8. The image processing apparatus according to claim 5, wherein the integration unit is configured to integrate a plurality of analysis charts into a single sheet by using information input by a user.

9. A system including an image processing apparatus and an apparatus connected to the image processing apparatus, the system comprising:
an image forming unit configured to form an image;
a designation unit configured to designate an area with respect to image data obtained by reading the image formed by the image forming unit;
an acquisition unit configured to acquire image feature information of image data included in the area designated by the designation unit;
an estimation unit configured to estimate a cause of an abnormal image included in the designated area by using the image feature information acquired by the acquisition unit;
a determination unit configured to determine a chart to be formed by the image forming unit by using an estimation result of the estimation unit; and
an identification unit configured to identify the cause of the abnormal image by using image data obtained by forming the chart determined by the determination unit and reading the formed chart.

10. A method for controlling an image processing apparatus including an image forming unit configured to form an image, the method comprising;
designating an area with respect to image data obtained by reading the image formed by the image forming unit;
acquiring image feature information of image data included in the area designated in the designating;
estimating a cause of an abnormal image in the designated area by using the image feature information acquired by the acquiring; and
determining a chart to be formed by the image forming unit by using a result of the estimating.

11. The method for controlling the image processing apparatus according to claim 10, further comprising transmitting image data obtained by forming the determined chart by the image forming unit and by reading the formed chart, to an apparatus connected to the image processing apparatus.

12. The method for controlling the image processing apparatus according to claim 10, wherein the image feature information is at least one of pieces of information on a color of an image included in the designated area, a halftone processing method used for forming the image included in the designated area, a percentage of a background area in the image in the designated area, a percentage of characters/lines in the image in the designated area, and a position of the image of the designated area.

13. The method for controlling the image processing apparatus according to claim 10, wherein the designating includes displaying a preview image of the image data obtained by reading the image formed by the image forming unit, and designating the area with respect to the displayed preview image.

14. The method for controlling the image processing apparatus according to claim 10, further comprising integrating a plurality of types of charts determined in the determining into a single sheet.

15. The method for controlling the image processing apparatus according to claim 14, wherein the charts are integrated by the integrating in a case where a number of charts determined in the determining is larger than a threshold value.

16. The method for controlling the image processing apparatus according to claim 14, wherein the integrating includes integrating a plurality of analysis charts into a single sheet by using information obtained from a shape of the designated area.

17. The method for controlling the image processing apparatus according to claim 14, wherein the integrating includes integrating a plurality of analysis charts into a single sheet by using information input by a user.

18. A non-transitory computer-readable storage medium storing a program for causing a computer to execute the method according to claim 10.
